(19) United States
(12) Patent Application Publication
(10) Pub. No.: US 2016/0154776 A1
(43) Pub. Date: Jun. 2, 2016

(54) STORY DISPLAY PROGRAM AND STORY DISPLAY SYSTEM

(71) Applicant: PEACH BOY INC., Urayasu-shi (JP)

(72) Inventor: Shinobu MIYAKE, Urayasu-shi (JP)

(73) Assignee: PEACH BOY INC., Urayasu-shi (JP)

(21) Appl. No.: 14/951,848

(22) Filed: Nov. 25, 2015

(30) Foreign Application Priority Data
Dec. 2, 2014 (JP) 2014-244393

(51) Int. Cl. G06F 17/24; G06T 11/60; G06F 17/21

(52) U.S. Cl. CPC G06F 17/24; G06F 17/217; G06F 17/212; G06T 11/60

(57) ABSTRACT

A story display program and a story display system capable of editing contents such as a novel in which a story can be developed intuitively and easily, as well as simply.

The story display program of the invention develops a predetermined story by displaying page data orderly, and has a function of making a computer execute a file read processing, a page display processing, and a page feed processing. Among them, the file read processing is a processing of reading out “page file”. The page file includes page combination information for defining the combination of a plurality of page data and display order information for defining the order of displaying page data.

### CROSS-REFERENCE TO RELATED APPLICATIONS

The disclosure of Japanese Patent Application No. 2014-244393 filed on Dec. 2, 2014 including the specification, drawings, and abstract is incorporated herein by reference in its entirety.

### BACKGROUND OF THE INVENTION

1. Field of the Invention

The present invention relates to a technique of displaying readings such as a novel, for example, a dramatic novel (GEKIGA) in which a story is developed, more specifically, the invention relates to a story display program and a story display system of displaying a predetermined story on a display of a device such as a smartphone.

2. Description of the Related Art

Heretofore, readings such as novels have been displayed predominantly as printed matters by using paper medium. Along with rapid progress of information technique in recent years, so-called electronic books that are displayed by using computers have been utilized frequently. As terminal equipment (devices) for displaying the electronic books, various equipment including, for example, personal computers, tablet type terminals and smartphones have been utilized.

When an electronic book is read by utilizing a tablet type terminal having a touch panel display or a smartphone, the following page is displayed predominantly by user's flick operation. Further, for a page that cannot be accommodated in a display, the user performs an swipe operation for changing the range of display.

In recent years, it is said that computer users have been shifted from browsing type to participation type. That is, users prefer not only to read the contents but also to positively utilize the contents in various manners, for example, giving their comments on the contents, editing the contents, or preparing new contents. On the other hand, in the case of the electronic books, users have not been used to edit novels of others' etc. and modification (edition) of novels, etc. per se dis not consider so far respecting the copy right.

However, since the contents of electronic books are easy to modify by their nature, there is a natural demand of intending to modify novels, etc. and preparing new stories for wide spreading such contents on the premise of obtaining permission of a copy right owner. In such a case, it is preferred for a user that the editing operation is actually easy and edition is possible by a simple operation, for example, replacement of page order, and deleting page or adding new page. However, in existent electronic books, one sentence is often displayed while overriding adjacent pages and is not in a file structure that can be edited page by page.

Then, JP-A 2004-145375 proposes a technique of structuring document data so as to facilitate editing operation.

JP-A 2004-145375 proposes a technique of digitizing every heading in a table of contents into data, and relating the text data corresponding to the heading, thereby replacing the display order of a text by replacing the order of the headings in the table.

While the editing operation can be facilitated by JP-A 2004-145375 compared with usual cases, the operation still cannot be said intuitively easy, for example, in a case where the document data is that of a novel. That is, when a novel or the like is edited, for example, by replacing the order of contents, partially deleting the contents, or adding new contents, the editing operation cannot be performed while confirming the result.

### SUMMARY OF THE INVENTION

The present invention intends to solve the problem of the prior art and provide a story display program and a story display system capable of easily editing contents such as a novel institutively in which a story is developed, as well as facilitating editing operation.

The present invention has been accomplished taking notice on the fact that a novel or the like is constituted with a plurality of pages and data is constructed on every one page. Data for one page is configured so as to be displayed within a display and further configured such that the contents can be recognized only on that page. Further, since a work includes pages each consisting only of images and pages each consisting only of text (characters), not only the work is easy to read but also the editing operation is very easy to understand.

“The story display program” of the present invention is a program of developing a predetermined story by displaying page data successively, and has a function of making a computer execute a file read processing, a page display processing, and a page feed processing. Among them, the file read processing is a processing of reading “page file”. “The page file” includes “page combination information” for defining combination of a plurality of page data and “display order information” for defining the order of displaying page data. The page display processing is a processing of displaying one page data so as to be accommodated as one page within a display screen based on the page combination information. Further, the page feed processing is a processing of changing the page data to be displayed in accordance with the display order information in response to s user's operation. The page data includes “text page data” consisting only of character information and “image page data” consisting only of image information, and the page combination information includes at least one text page data and at least one image page data.

“The story display program” of the present invention can be further provided with a function of making the computer execute the data addition/deletion processing. The data addition/deletion processing can delete page data included in the page combination information, as well as can add a new page data to the page combination information.

“The story display program” of the present invention may also be provided with a function of making the computer execute a display order edition processing capable of changing the display order information.

“The story display program” of the present invention may further be provided with a function of making the computer execute selection processing. The selection processing is a processing that allows a user to select a desired option based on the option information displayed by the page display processing. In this case, the page combination information includes a page data having option information and the display order information includes a branch display order information by which the display order branches into plurality. Then, the page feed processing decides one branched display order information based on the option selected from a plurality of branch display order information.

“The story display program” of the present invention may also be adapted to display images. In this case, the page combination information includes page data having the image information and the page display processing displays the information for image reproduction on a display means. Then, the page feed processing reproduces video images corresponding to the video information in response to the user's operation.

“The story display program” of the present invention may also have a function of making the computer execute a voice output processing for outputting read out voice data. In this case, the file read out processing reads out voice data having voice information.

“The story display system” of the present invention is a system of developing a predetermined story by outputting page data in a predetermined order to a display means based on a page file and includes a page file edition means, a file storage means, a file selection means, a page display means, and a page feed means. Among them, the page file edition means is a means for preparing different page files by editing the page combination information or the display order information based on the page file. The file storage means is a means for storing a plurality of page files (including page files prepared by the page file edition means) for every title. The file selection means is a means for displaying, in a list, file identification information of specifying a page file and capable of selecting desired file identification information. The page display means is a means for displaying one page data as one page so as to be accommodated within a display screen based on the page combination information of the page file corresponding to the selected file densification information. Then, the page feed means is a means for changing the page data to be displayed in accordance with the display order information of the page file corresponding to a file identification information selected in response to the user's operation.

“The story display system” of the present invention may be further provided also with a file vote means for allowing users to vote to the page file. In this case, the file selection means changes the display order of the file identification information displayed, in a list, for every title in accordance with the number of votes obtained by the file vote means.

“The story display system” of the present invention may be further provided also with a page vote means for allowing users to vote to the page data. In this case, the page file edition means prepares different page files in accordance with the number of votes obtained by the page vote means.

### Advantage of Invention

The story display program and the story display system of the present invention provides the following advantageous effects.

(1) Since general users can edit novels, etc., new participation type contents can be provided.

(2) Operation is facilitated since edition can be performed page by page and, further, operation is intuitive and easy to understand since edition can be conducted while observing pages.

(3) Since the story is developed for the page only consisting of the image and for the page only consisting of the text, it is very easy to read.

### BRIEF DESCRIPTION OF THE DRAWINGS

FIG. 1 is an explanatory view illustrating development of a story by page data;

FIG. 2 is an explanatory view illustrating a page file in which a page combination information and a display order information are described;

FIG. 3A is an explanatory view illustrating a state in which text page data is displayed on a display of a smartphone and

FIG. 3B is an explanatory view illustrating a state in which image page data is displayed on a display of a smartphone;

FIG. 4 is a block diagram illustrating a story display system of the present invention;

FIG. 5 is a model chart illustrating file identifiers displayed in a list on a display means;

FIG. 6 is a block diagram partially illustrating a story display system provided with a page file edition means;

FIG. 7 is an explanatory view illustrating data addition/deletion processing of the page file;

FIG. 8 is an explanatory view illustrating a display order edition processing of the page file;

FIG. 9 is an explanatory view illustrating that two option information of “appropriate” and “inappropriate” are displayed on a display;

FIG. 10 is an explanatory view illustrating a page file in a case where a story is branched in the midway;

FIG. 11 is an explanatory view illustrating a story development in a case of reproducing a video image;

FIG. 12 is an explanatory view illustrating a story development in a case of outputting voice;

FIG. 13 is an explanatory view illustrating that a link information is displayed on a display;

FIG. 14 is a block diagram partially illustrating a story display system provided with a file vote means; and

FIG. 15 is a block diagram illustrating the configuration of voting to predetermined page data in one page file.

### DESCRIPTION OF REFERENCES

100 story display system
101 page data input means
102 page data storage means
103 page file input means
104 page file storage means
105 file identifier read means
106 file identifier display means
107 file selection means
108 page file read means
109 page data read means
110 page display means
111 page feed means
112 page file edition means
113 file vote means
114 file vote information storage means
115 vote information read means
116 file identifier re-arrangement means
117 page vote means
118 page vote information storage means

### DETAILED DESCRIPTION OF THE PREFERRED EMBODIMENTS

Examples of a story display program and a story display system of the present invention are to be explained with reference to the drawings.

### 1. Outline for the Entirety of the Invention

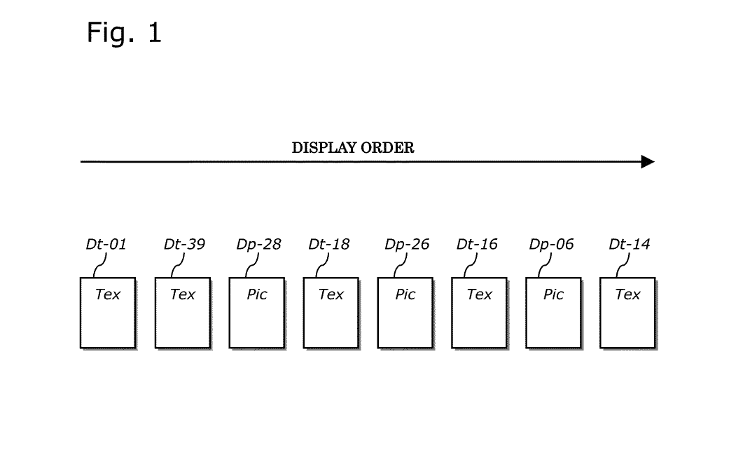

According to the present invention, a plurality of pages are displayed orderly on a device such as a tablet type terminal, a smartphone, or a personal computer to develop a story. For example, in FIG. 1, page data by the number of eight are selected from a plurality of page data and such page data are displayed in a predetermined order thereby developing a story. The pages are turned (transited) by a user's operation such as flicking or tapping in a case of a device having a touch panel type display and a user's operation such as click in a case of a personal computer.

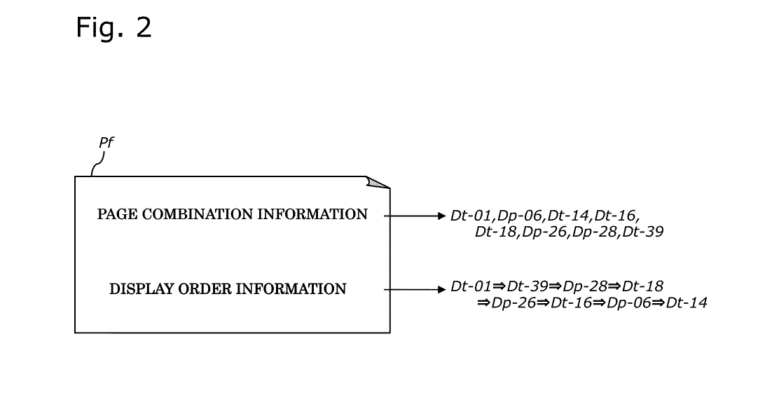

Referring more specifically to FIG. 1, page data by the number of eight, that is, page data Dt-01, Dt-14, Dt-16, Dt-18, Dt-39, Dp-06, Dp-26, and Dp-28 are selected from a considerable number of page data and combined, and they are displayed in the order of the page data Dt-01→Dt-39→Dp-28→Dt-18→Dp-26→Dt-16→Dp-06→Dt-14 thereby transmitting a story to a reader (user). A page file Pf shown in FIG. 2 determines such combination and display order of page data. As illustrated in FIG. 2, “page combination information” defines combination of a plurality (by the number of 8 in the drawing) of the page data and “display order information” defines the order of displaying the page data, and such page combination information and display order information are described in the page file Pf.

In the page data, contents displayed as one screen on a display of a device are defined as one data file. Accordingly, the page data corresponding for every kind of device or product may be prepared. Then, the page data include two types of data, that is, “text page data” consisting only of a text (characters) and “image page data” consisting only of image information. FIG. 1 represents the text page data as Dt and the image page data as Dp.

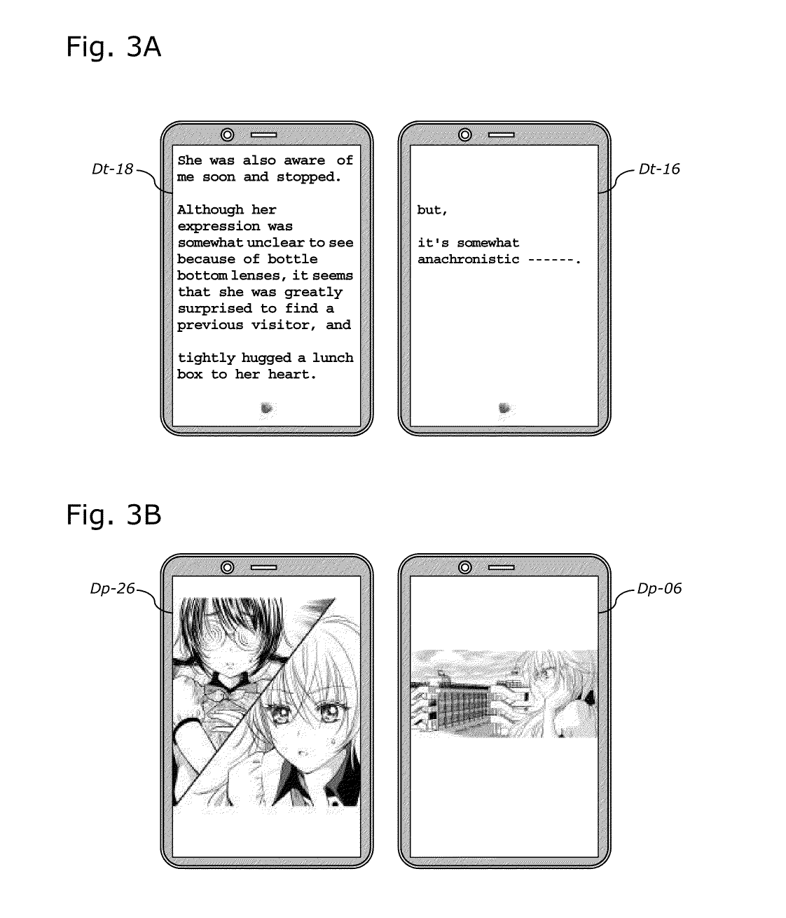

FIGS. 3A, 3B are explanatory views illustrating the state of the page data displayed on a display of a smartphone in which FIG. 3A illustrates a case of text page data and FIG. 3B illustrates a case of image page data. As can be seen from the drawings, one page data is configured such that the data is displayed so as to be accommodated in the display and the situation can be recognized only by the page. Accordingly, in a case of the text page data, end of the page is closed by a period “.” or a parenthesis such as “┘” or “)” and the image page data may be configured with one image. In the case of the text page data, a limit value (threshold value) can also be set for the number of characters. Also in this case, the limit value may be set individually for every kind of device or product.

### 2. Constituent Elements

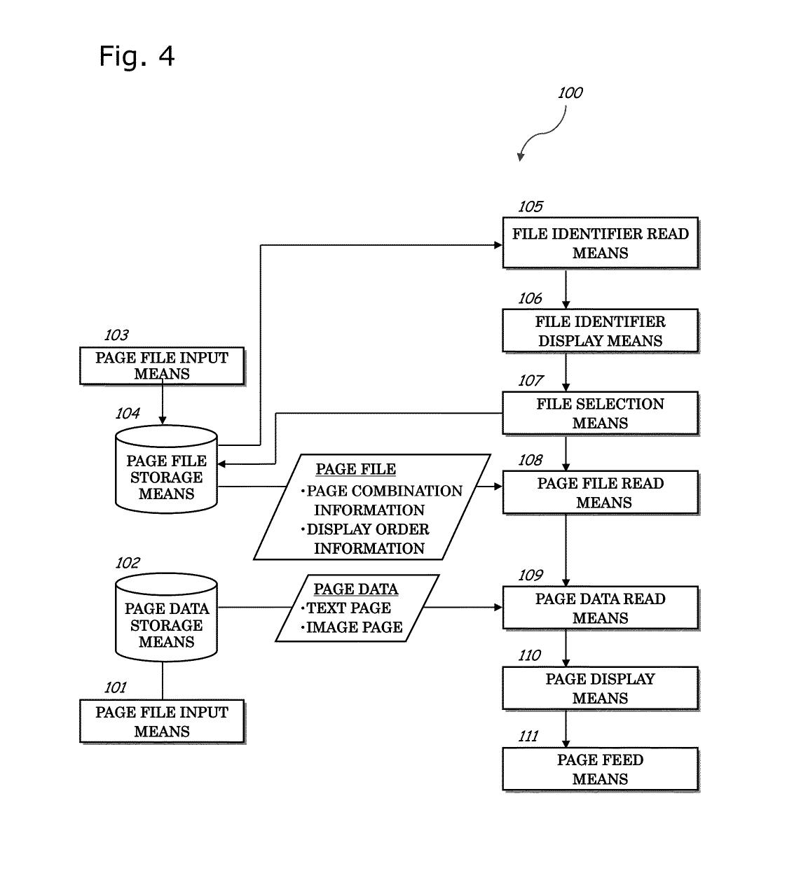

FIG. 4 is a block diagram illustrating a story display system 100 of the present invention. Each of the elements constituting the present invention is to be described specifically with reference to the drawing. While the story display system 100 can be manufactured by a system for an exclusive use, a general-purpose computer device can also be used. The computer device may be, for example, a personal computer, a tablet PC such as an iPad (registered trademark), or PDA (Personal Data Assistance).

### (Page Data Storage Means)

The text page data Dt and the image page data Dp are inputted through a page data input means 101 and stored in a page data storage means 102. The page data can be stored for every work (title) such as a novel and can be stored with no particular classification. The page data is provided with a file name capable of being identified from other data, or related with an identifier for identifying from other data.

### (Page File Storage Means)

A page file Pf is inputted through a page file input means 103 and stored in a page file storage means 104. The page file Pf is stored for every title. That is, the page file storage means 104 can store a number of page files Pf for one title and, accordingly, the page file Pf is stored being related with an identifier for identifying from others (hereinafter referred to as “file identifier”).

### (Display of File Identifier)

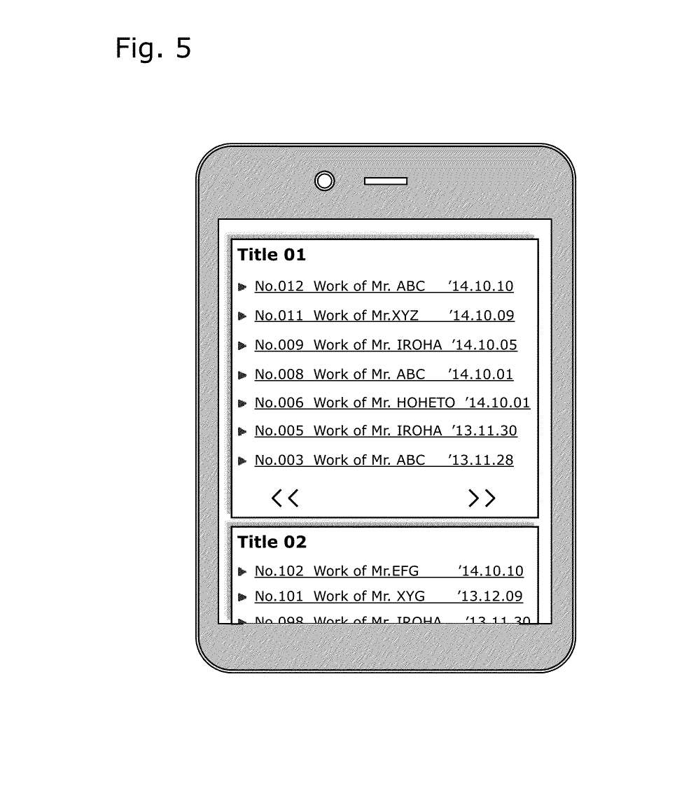

When a user reads a novel or the like by utilizing the present invention, the user first designates a title and selects a desired one from individual works stored for every title (that is, page file Pf). Specifically, when the user designates the title, a file identifier read means 105 reads a file identifier of the title. Then, the read file identifier is displayed on a display by a file identifier display means 106. FIG. 5 is a model chart showing file identifiers displayed, in a list, on a display means (display). In the example of the drawing, the identifier is configured, for example, as “No. 102” and, in addition to the identifier, simple information with regard to the page file Pf, for example, worker's name, and registration date are also displayed.

When the list of the file identifiers is displayed on every title, the user selects one page file Pf by tap operation or the like. A file selection means 107 selects the file identifier and, further, inquires by means of the selected file identifier to the page file storage means 104. The page file Pf specified in accordance with a inquiry from a file selection means 107 is read out by a page file read means 108.

### (Display of Page Data)

A page data read means 109 reads out a predetermined page data from the page data storage means 102 in accordance with the page combination information described in the page file Pf. For example, in the example of FIG. 1, page data by the number of eight are read out. Further, the read out page data are re-arranged in a predetermined order in accordance with the display order information described in the page file Pf. Then, a page display means 110 displays the page data at the top on the display. In this case, the page data are displayed such that one page data is accommodated in the display as described above.

### (Transition of Page)

The page is turned to the next page in response to a user's operation such as flicking, tapping, or clicking. In this case, a page feed means 111 designates an appropriate page data in accordance with the display order information described in the page file Pf, and the page data is displayed by the page display means 110.

### (Edition of Page File)

Different page files Pf can be prepared by editing the page file Pf. That is, works of different versions are prepared based on an original work. As a result, as shown in FIG. 5, a plurality of works (page files Pf) are prepared for one title.

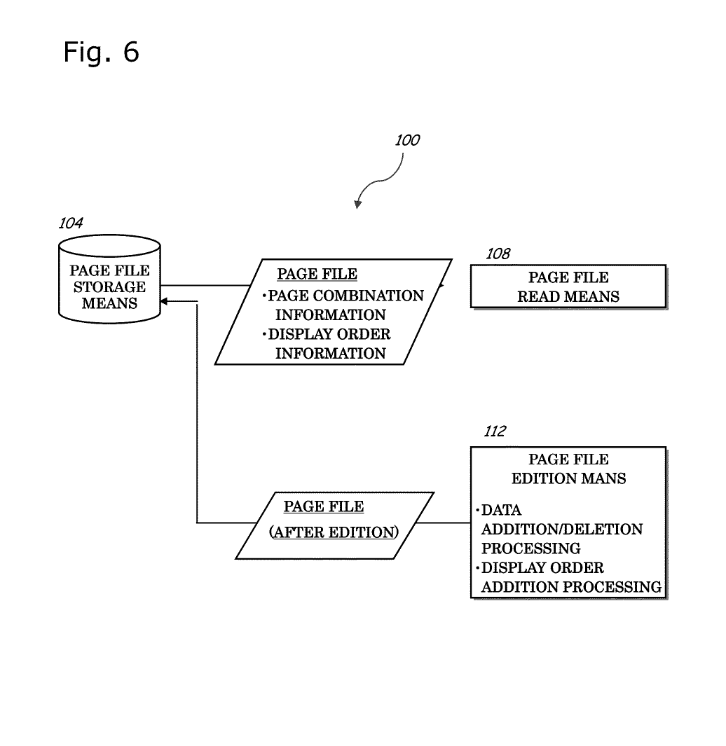

FIG. 6 is a block diagram partially illustrating the story display system 100 having a page file edition means 112. When a page file Pf is edited, a page file read means 108 reads out a desired page file Pf, the page file edition means 112 edits the page file Pf, and the page file Pf after edition is stored as a different page file in a page file storage means 104.

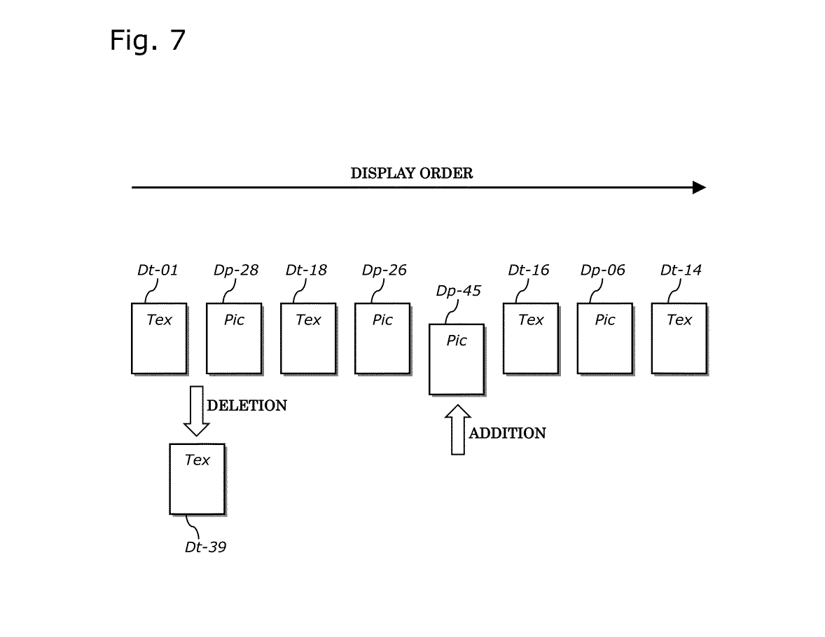

The page file edition means 112 can perform edition processing of the page file Pf such as data addition/deletion processing and display order edition processing. FIG. 7 is an explanatory view illustrating the data addition/deletion processing of the page file Pf. As illustrated in the drawing, optional page data can be deleted and a new page data can be added due to the page combination information described in the page file Pf.

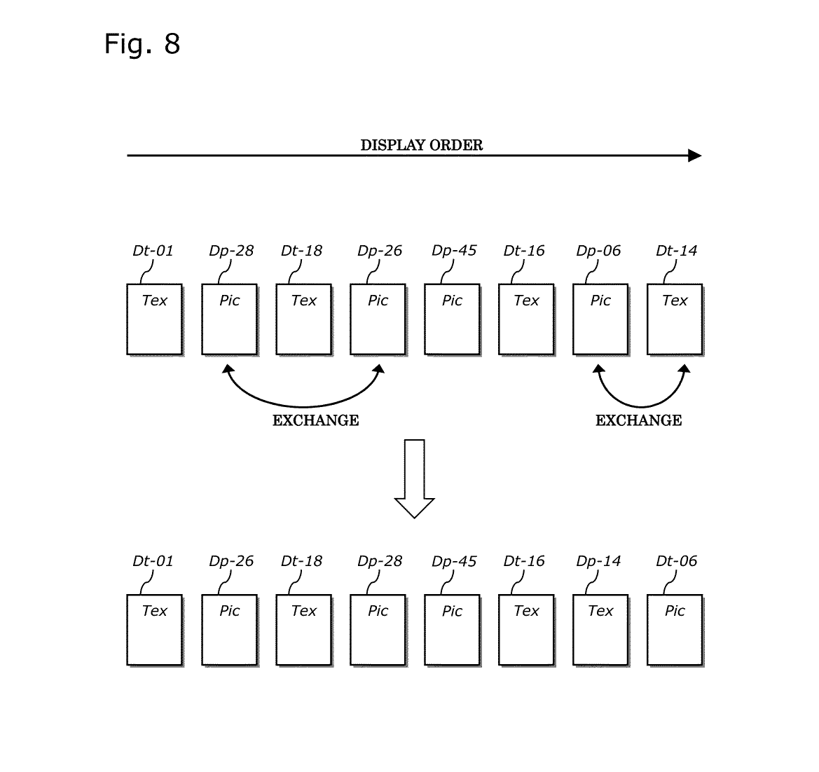

On the other hand, FIG. 8 is an explanatory view illustrating a display order edition processing of the page file Pf. As illustrated in the drawing, in the display order edition processing, the order of the page data to be displayed can be changed for the display order information described in the page file Pf. Of course, the order can be replaced between the image page data each other and between the text page data each other, as well as the order can be replaced between the image page data and the text page data.

### (Branch of Story)

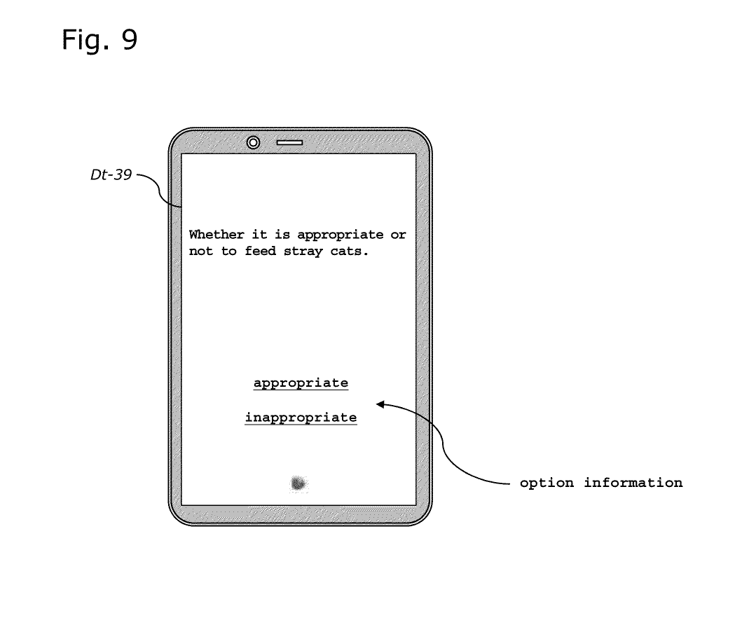

The story may be developed in one way or the subsequent development can also be changed in response to a user's selection in the midway. For example, an option information is provided to the page data and displayed on the display for user's selection. FIG. 9 is an explanatory view showing that two option information of “appropriate” and “inappropriate” are displayed on the display. A user selects either one of “appropriate”/“inappropriate” in accordance with the judgment of the user per se with reference to the development of the story so far, and inputs the result by an operation such as tapping.

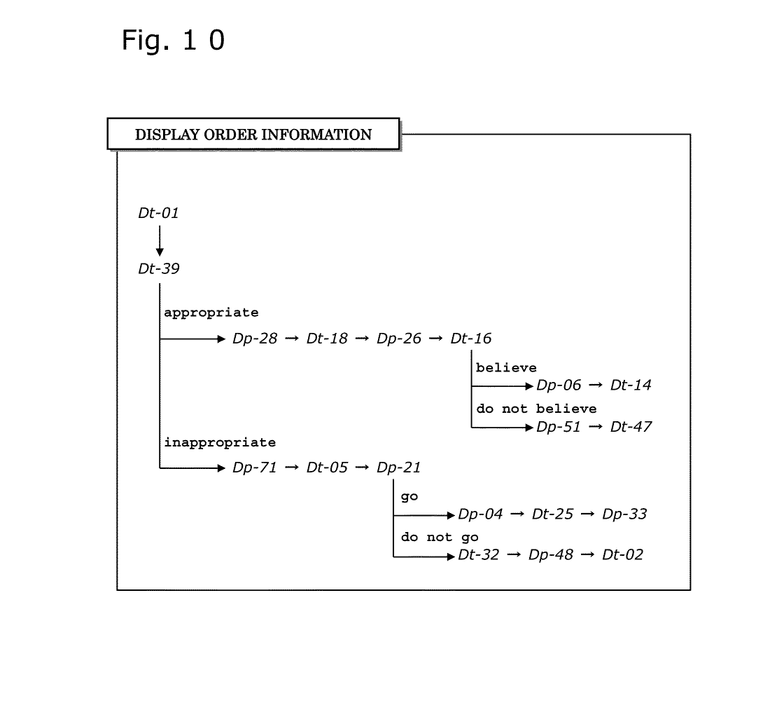

In a case where the story is branched in the midway, the page file Pf can be formed, for example, as illustrated in FIG. 10. In the drawing, alternative option information is described for the page data Dt-39, the page data Dt-16, and the page data Dt-21 and, when the page data are displayed, the option information is also displayed correspondingly, and the page feed means 111 decides subsequent page data and the display order thereof (branch display order information) in accordance with the inputted option.

### (Reproduction of Video Image)

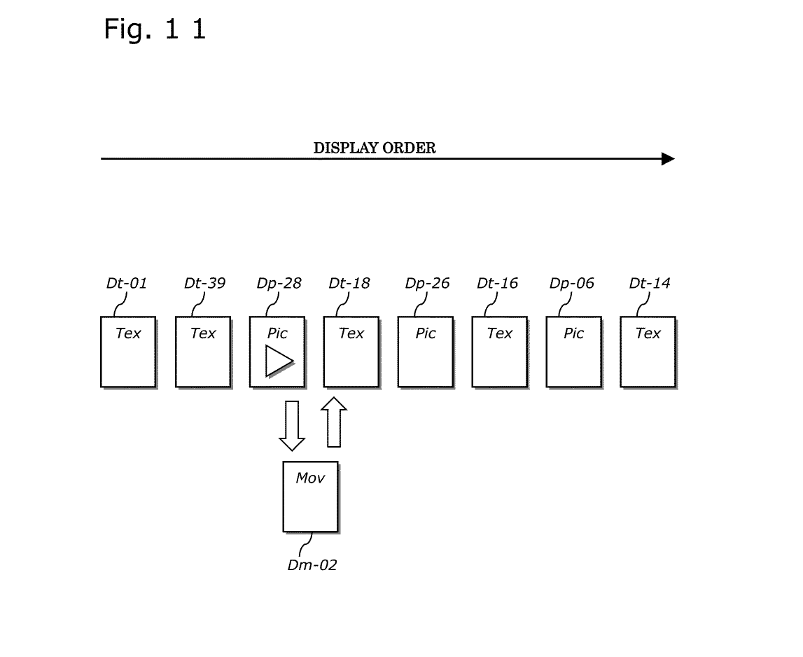

The page data can be provided also with information for video image (hereinafter referred to as “video information”). FIG. 11 is an explanatory view illustrating the development of a story when a video image is reproduced. In the drawing, video information of video data Dm-02 is described in page data Dp-28 and the image data Dm-02 is read out and reproduced in response to a user's operation when the page data Dp-28 is displayed. When the reproduction is completed, the original page data Dp-28 or the next page data Dt-18 is displayed. When page data including video image information is displayed, information for video image reproduction, for example, a reproduction button illustrated, for example, in FIG. 11 is also displayed together.

### (Voice Output)

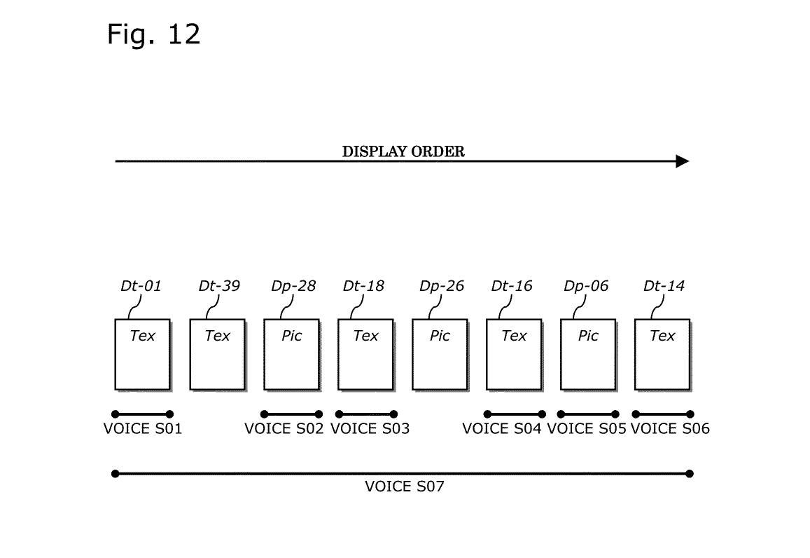

The page data or the page file Pf can be provided also with information for voice (hereinafter referred to as “voice information”). FIG. 12 is an explanatory view illustrating the development of the story in which voice is outputted. In the drawing, page data Dp-01 contains voice information for voice S01. In the same manner, predetermined voice information are contained in the page data Dp-28. Dt-18, Dt-16, Dp-06, and Dt-14, respectively. The page file Pf contains voice information for voice S07. As a result, when the page data including the voice information is displayed, voice data corresponding to the voice information is read out and outputted by a voice output means (processing). When the page file Pf includes the voice information, the read out voice data is outputted for a predetermined period (for example, from the beginning to the end of the page file).

### (Display of Link)

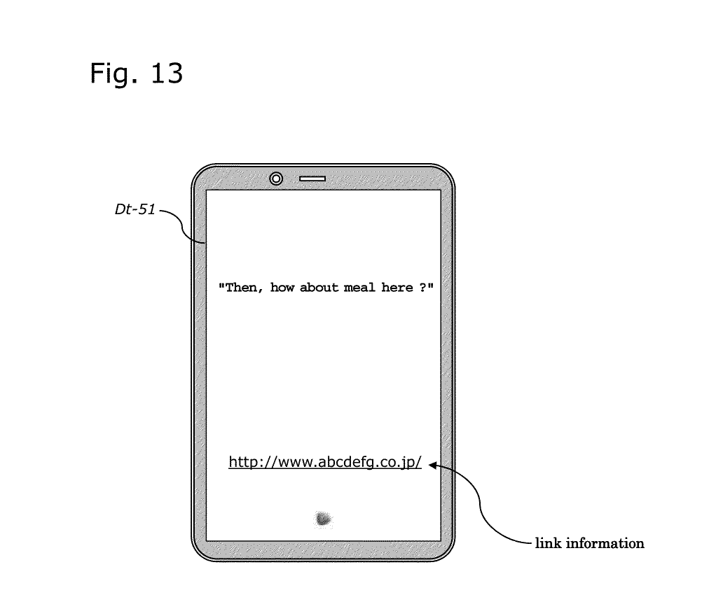

Page data can also be provided with information such as URL for transition to other sites (hereinafter refer to as “link information”). FIG. 13 is an explanatory view showing that the link information is displayed on a display. As illustrated in the drawing, when a user is introduced to the site of a food service industry, since the buying intention of the user is increased when the scene for foods is displayed, advertising effect can be enhanced. In addition to URL, it is also possible for direct display of advertisement, provision of affiliate function, display of a map, or display of various link information.

### (Metadata)

In addition, the page data can be provided also with metadata. As the metadata, property information such as time and place of a scene of the page and characters can be illustrated. By the provision of such information, processing such as re-arrangement of page data (that is, change of display order information) for a predetermined purpose can be conducted extremely easily. In this respect, it is not always necessary to display the metadata.

### (File Voting)

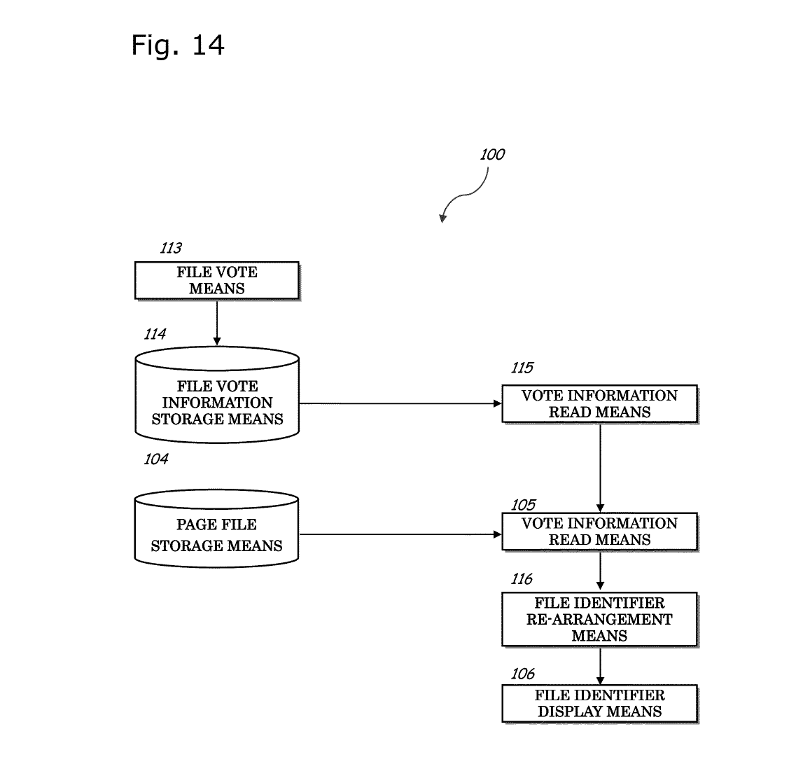

In FIG. 5, file identifiers are displayed in a list in the order of registration date, but this is not restrictive and they may be listed in various orders. For example, when the identifiers are listed in accordance with the evaluation of users who read the titles, this is suitable as a reference for selection of works. FIG. 14 is a block diagram partially illustrating a story display system 100 provided with a file vote means. When users who read the titles input that the users vote to desired works (page file Pf) by a file vote means 113, the result is stored in a voting information storage means 114. A voting information read means 115 reads out the voting information provided to the page file Pf from the vote information storage means 114 and, depending on the result, a file identifier re-arrangement means 116 rearranges the file identifiers. For example, a plurality of file identifiers read out by the file identifier read means 105 can be listed in the order of the identifier obtaining more number of votes by the file identifier display means 106.

### (Page Voting)

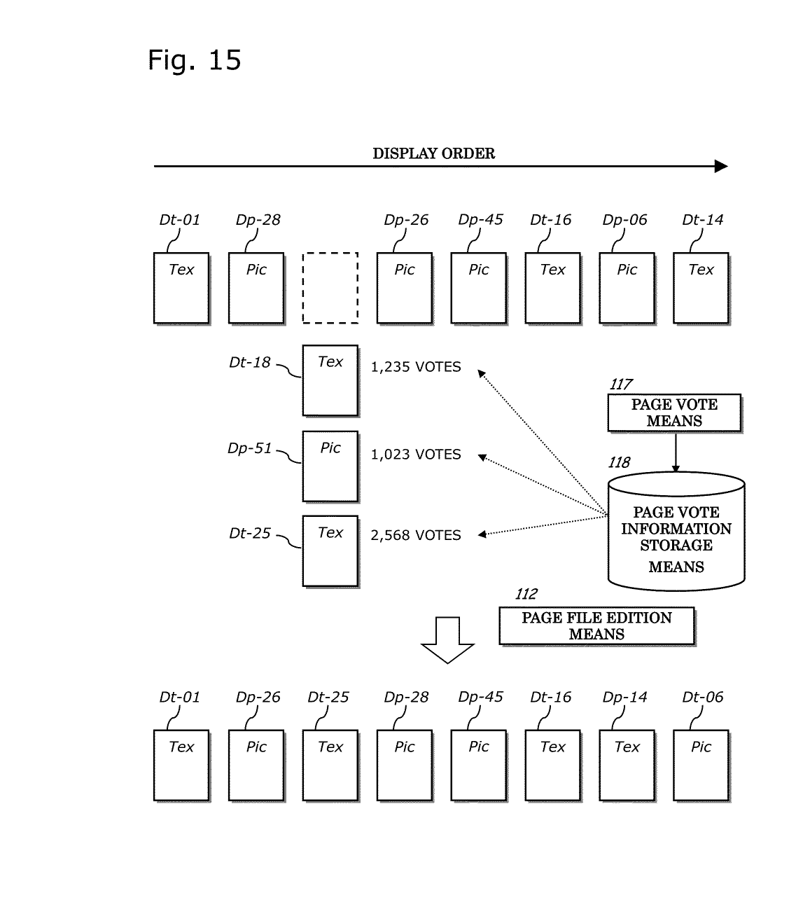

It is also possible to adopt voting not only to the page file Pf but also to the page data. FIG. 15 is a block diagram illustrating a configuration of voting to predetermined page data in one page file Pf. In the drawing, Dt-18, Dp-51, and Dt-25 are shown as candidates for page data to be displayed at a third place and users who read the title vote to respective pages. Specifically, users input to the effect that they vote desired page data by a page vote means 117 and the result thereof is stored in a page vote information storage means 118. Then, a page file edition means 112 reads out the result of voting from a page vote information storage means 118 and selects, for example, page data obtaining the greatest number of votes, prepares a new page file Pf, and stores the same in a page file memory means 104. In the example of FIG. 15, Dt-25 obtains the greatest number of votes and the page file edition means 112 describes to the page file Pf that the page data Dt-25 is to be displayed at the third place.

### INDUSTRIAL APPLICABILITY

The story display program and the story display system of the present invention can be utilized to various readings including novels, as well as essays, articles, poems and travels, and applications to various industrial fields can be expected for the invention in the feature.

1. A story display program of developing a predetermined story by displaying page data orderly
the program having a function of making a computer execute:
a file read processing of reading out a page file including a page combination information for defining the combination of a plurality of the page data and a display order information for defining the order of displaying the page data,
a page display processing of displaying one page data as one page so as to be accommodated within a display screen based on the page combination information, and
a page feed processing of changing the page data to be displayed in accordance with the display order information in response to a user's operation, in which
the page data includes text page data consisting only of character information and image page data consisting only of image information, and
the page combination information includes at least one text page data and at least one image page data.

2. The story display program according to claim 1, further including
a function of making the computer execute,
data addition/deletion processing capable of deleting the page data included in the page combination formation and adding the new page data to the page combination information, and
a display order edition processing capable of changing the display order information.

3. The story display program according to claim 1, wherein
the page combination information includes the page data having option information, and the display order information includes branch display order information in which the display order is branched into plural ways, and wherein
the program further comprises a function of making the computer execute a selection processing for allowing a user to select a desired option from the option information displayed by the page display processing, and
the page feed processing determines one branched display order information based on the option selected from among the plurality of branch display information.

4. The story display program according to claim 1, wherein
the page combination information includes the page data having video image information,
the page display processing displays information for video image reproduction to the display means, and
the page feed processing reproduces video images corresponding to the video image information in response to a user's operation.

5. The story display program according to claim 1, wherein
the file read processing further has a function of making the computer execute,
a voice output processing of reading voice data having voice information and
outputting the read out voice data.

6. A story display system of developing a predetermined story by outputting page data in a predetermined order on a display means based on a page file including a page combination information for defining the combination of a plurality of page data and a display order information for defining the order of displaying the page data, the system including:
a page file edition means of preparing a different page file by editing the page combination information or the display order information based on the page file,
a file storage means of storing a plurality of the page files containing the page file prepared by the page file edition means for every title,
a file selection means of displaying, in a list, file identification information for defining the page file for every title and capable of selecting a desired file identification information,
a page display means of displaying the one page data as one page so as to be accommodated within a display screen based on the page combination information of the page file corresponding to the selected file identification information, and
a page feed means of changing the page data to be displayed in accordance with the display order information of the page file corresponding to the selected file identification information in response to a user's operation, in which
the page data includes text page data consisting only of character information and image page data consisting only of image information, and
the page combination information includes at least one text page data and at least one image page data.

7. The story display program according to claim 2, wherein
the page combination information includes the page data having option information, and the display order information includes branch display order information in which the display order is branched into plural ways, and wherein
the program further comprises a function of making the computer execute a selection processing for allowing a user to select a desired option from the option information displayed by the page display processing, and
the page feed processing determines one branched display order information based on the option selected from among the plurality of branch display information.

8. The story display program according to claim 2, wherein
the page combination information includes the page data having video image information,
the page display processing displays information for video image reproduction to the display means, and
the page feed processing reproduces video images corresponding to the video image information in response to a user's operation.

9. The story display program according to claim 2, wherein the file read processing further has a function of making the computer execute, a voice output processing of reading voice data having voice information and outputting the read out voice data.
